(19) United States
(12) Patent Application Publication
(10) Pub. No.: US 2025/0388288 A1
(43) Pub. Date: Dec. 25, 2025

(54) Method for Operating a Drive Unit of an Electric Bicycle

(71) Applicant: Robert Bosch GmbH, Stuttgart (DE)

(72) Inventors: Merlin Martin Manewald, Reutlingen (DE); Sebastian Eberle, Tuebingen (DE); Jim Rebholz, Reutlingen (DE); Matthias Weinmann, Balingen (DE); Christian Reisige, Tuebingen (DE); Joseph Reck, Weil Im Schoenbuch (DE)

(21) Appl. No.: 18/877,479

(22) PCT Filed: Jun. 16, 2023
(86) PCT No.: PCT/EP2023/066280

§ 371 Date: Dec. 20, 2024

(30) Foreign Application Priority Data
Jun. 22, 2022 (DE) 10 2022 206 272.8

(51) Int. Cl. B62M 6/50

(52) U.S. Cl. CPC B62M 6/50

(57) ABSTRACT

A method for operating a drive unit of an electric bicycle includes (i) determining a rider torque signal, which is based on a rider torque generated by way of muscle power of a person riding the electric bicycle, (ii) first filtering of the rider torque signal by way of a first low-pass filter, (iii) second filtering of the rider torque signal by way of a second low-pass filter, and (iv) generating, in a controlled manner, a motor torque by way of the drive unit as a function of the rider torque signal filtered by way of the second low-pass filter.

### PRIOR ART

The present invention relates to a method for operating a drive unit for an electric bicycle, as well as to an electric bicycle.

Electric bicycle wheels having drive units to support rider torque generated by a rider by means of motor force are known. Motor support is usually only provided if the rider himself applies a certain rider torque, that is to say only during pedal actuation by the rider. If the rider stops the pedal actuation, it is provided or, for example, required by law that the generation of a supporting motor torque stops. Often, a motor-generated drive torque of the drive unit is controlled as a function of a rider torque detected by means of sensors. The fluctuations of the rider torque occurring during pedaling can turn out very differently, as a result of which the supply of the motor torque can also fluctuate greatly, which can negatively affect the ride comfort.

### DISCLOSURE OF THE INVENTION

By contrast, the method according to the invention, having the features of claim 1, is characterized in that a simple and cost-efficient option for precisely regulating or controlling a drive torque of a drive unit of an electric bicycle can be provided, which allows for a particularly high ride comfort for a rider of the electric bicycle. This is achieved by a method for operating a drive unit of an electric bicycle, comprising the following steps:
determining a rider torque signal, which is based on a rider torque generated by means of muscle power of a person riding the electric bicycle,
first filtering of the rider torque signal by means of a first low-pass filter,
second filtering of the rider torque signal by means of a second low-pass filter, and
generating, in a controlled manner, a motor torque by means of the drive unit as a function of the rider torque signal filtered by means of the second low-pass filter.

In particular, a value of the rider torque currently generated by the rider, which is preferably detected by means of a torque sensor, is considered as the rider torque signal. Alternatively preferably, the rider torque signal can be any desired signal or information representing the generated rider torque and thus, in particular, reflects a rider's desire with respect to motor support of the drive unit.

Preferably, the second filtering of the rider torque signal by means of the second low-pass filter occurs temporally after the first filtering of the rider torque signal by means of the first low-pass filter.

Particularly preferably, in the controlled generation of the motor torque, the drive unit is controlled in such a way that the generated motor torque is directly proportional to the rider torque signal filtered by means of the second low-pass filter.

In other words, in the method there is a controlling of the motor torque generated by the drive unit based on a rider torque signal filtered by means of two separate low-pass filters. Thereby, a particularly flexible actuation of the drive unit can be carried out, in order to provide as optimum a motor torque as possible for a high ride comfort. On the one hand, in particular, torque fluctuations of the rider torque can be filtered out strongly as needed, thereby enabling a particularly uniform motor torque curve. For example, a “wobbling” of the motor support can thereby be avoided. On the other hand, in other situations, a high reactivity of the motor support of the drive unit can be provided, that is to say, a temporally fast and direct implementation of the rider's request. This is achieved by providing particularly high flexibility in the filtering of the rider torque signal by means of the two separate low-pass filters. In particular, at least one of the two low-pass filters can be configured adaptively in order to enable an optimum adjustment to the respective ride situations during ride operation.

The dependent claims show preferred refinements of the invention.

Preferably, the second low-pass filter has a variable time constant. While carrying out the method, the variable time constant is adjusted as a function of the rider torque signal. In other words, the variable time constant of the low-pass filter is actively adjusted to the current curve of the rider torque signal. For example, an increase in the variable time constant can be made in order to cause greater smoothing of the rider torque signal. Alternatively, a reduction of the variable time constant can be made in order to cause less strong smoothing of the rider torque signal, and thus to provide higher reactivity of the motor.

Particularly preferably, the method further comprises the following step: determining a difference of the rider torque signal between an input and an output of the second low-pass filter. The variable time constant of the second low-pass filter is thereby adjusted as a function of the determined difference. That is to say, the values of the rider torque signal present at the input and the output of the second low-pass filter, respectively, are subtracted from each other to form the difference. As a function of the amount of the difference, the variable time constant of the second low-pass filter is adjusted. An adaptation of the filtering can thus be carried out in a particularly simple manner.

Preferably, the variable time constant of the second low-pass filter is increased as it is determined that the difference is decreasing. For example, a decreasing difference can be determined by detecting the differences over a predetermined time period. Alternatively, a gradient of the differences can be determined, and a decrease of the differences can be found based thereon. Based on the determined decreasing difference, or alternatively based on a low current value of the difference, a constant, homogeneous ride situation can be inferred. In this case, for example, a low reactivity of the drive is required. Thus, a strong smoothing of the rider torque signal can be implemented in order to prevent undesirable fluctuations in the motor torque and thus to provide a particularly high ride comfort.

Preferably, the variable time constant of the second low-pass filter is decreased as it is determined that the difference is increasing. For example, an increasing difference can be determined by detecting the differences over a predetermined time period. Alternatively, a gradient of the differences can be determined, and an increase of the differences can be found based thereon. Based on the determined increasing difference, or alternatively based on a high current value of the difference, a dynamic ride situation, for example a technically challenging ride situation, can be inferred. In this case, for example, a high reactivity of the drive is desired. By reducing the variable time constant of the second low-pass filter, the filtering by means of the second low-pass filter is reduced or entirely deactivated. For example, the variable time constant can be set equal to zero. A particularly direct and fast implementation of the rider desire for a motor torque can thus be enabled.

Further preferably, the variable time constant of the second low-pass filter is reduced to a value less than or equal to a predetermined threshold time constant when the determined difference is greater than or equal to a predetermined threshold difference. As a result, a high reactivity of the drive can be provided in an analogous manner to what has been described above. Alternatively or additionally preferably, the variable time constant of the second low-pass filter is increased to a value greater than the predetermined threshold time constant when the determined difference is less than the predetermined threshold difference. As a result, an operating mode of the drive unit can also be provided analogously to what has been described above, in which a strong filtering is implemented in order to prevent undesirable torque fluctuations in the motor torque. In addition, the method can be reliably carried out in a particularly straightforward manner.

Further preferably, the determining of the rider torque signal comprises the following step: recording the rider torque signal over a predetermined time period. The variable time constant of the second low-pass filter is adjusted as a function of the recorded rider torque signal. For example, the rider torque signal can be recorded over a period of five seconds. Thus, a further simplification of the method and an even more precise alignment of the ride comfort can be achieved.

Preferably, the method further comprises the following step: determining a maximum value of the recorded rider torque signal, in particular within the predetermined time period. The variable time constant of the second low-pass filter is adjusted as a function of the determined maximum value. Thus, the method can be carried out in a particularly simple and cost-effective manner.

Particularly preferably, the method further comprises the following step: multiplying the rider torque signal by a support factor. The controlled generation of the motor torque is carried out by means of the rider torque signal that has been multiplied by the support factor. For example, the support factor can be a predetermined constant value. Alternatively preferably, the support factor can be variably, i.e. adaptively, configured and can be adjusted, for example, as a function of the level of the rider torque signal. Thus, the control of the drive unit can be carried out in a particularly straightforward manner.

The multiplying of the rider torque signal occurs preferably before the second filtering, in particular between the first filtering by means of the first low-pass filter and the second filtering by means of the second low-pass filter. That is to say, by means of the second filter, the rider torque signal already multiplied by the support factor is filtered.

Alternatively, the rider torque signal is multiplied after the second filtering. In that case, the first filtering and the second filtering preferably occur immediately in succession.

Further preferably, the first low-pass filter has a predetermined first time constant, which has a constant value. The method can thus be carried out particularly simply and inexpensively, wherein an optimal processing of the rider torque signal can be provided in order to enable as high a ride comfort as possible.

Furthermore, the invention results in an electric bicycle comprising a drive unit, in particular configured so as to generate a motor torque for supporting a muscle power of the rider of the electric bicycle, and a control unit. The control unit is preferably configured so as to actuate the drive unit in a controlled manner. Furthermore, the control unit is configured so as to carry out the method described.

### BRIEF DESCRIPTION OF THE DRAWINGS

Exemplary embodiments of the invention are explained in detail below with reference to the accompanying drawings. The drawing shows:

FIG. 1 a simplified schematic view of an electric bicycle in which a method for operating a drive unit of the electric bicycle according to a first exemplary embodiment of the invention is carried out,

FIG. 2 a simplified view of an exemplary temporal torque curve, in which the method according to the first exemplary embodiment is carried out,

FIG. 3 a simplified view of an execution of the method according to the first exemplary embodiment, and

FIG. 4 a simplified view of an execution of a method according to a second exemplary embodiment of the invention.

### EMBODIMENTS OF THE INVENTION

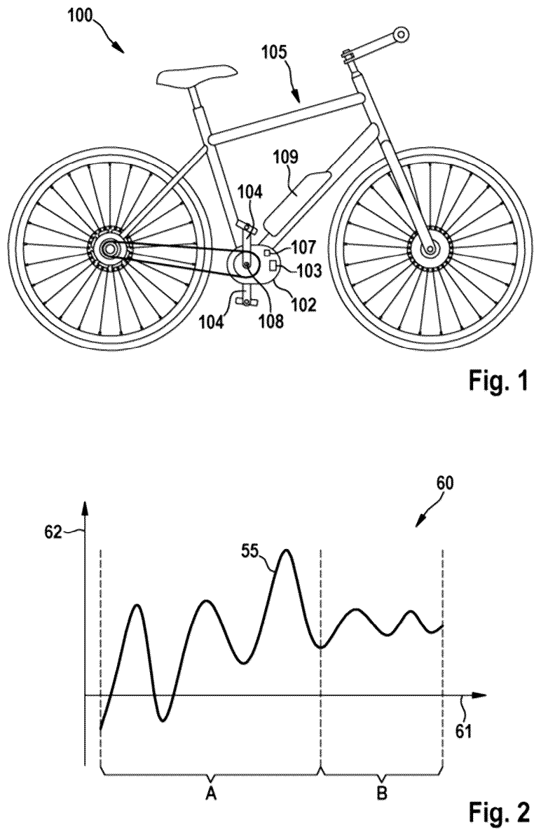

FIG. 1 shows a simplified schematic view of an electric bicycle 100. The electric bicycle 100 comprises a drive unit 102, which is configured as an electric motor. The drive unit 102 is arranged in the region of a bottom bracket 108 of the electric bicycle 100 and is provided in order to support a manual pedal force of a rider of the electric bicycle 100 applied via a crank drive 104 with a torque generated by an electric motor.

Furthermore, the electric bicycle 100 comprises an electrical energy store 109 by means of which the drive unit 102 is supplied with electrical energy. The drive unit 102 also comprises an integrated control unit 103.

The control unit 103 is configured so as to operate the drive unit 102 as a function of the pedal actuation of a rider of the electric bicycle 100. Specifically, the drive unit 102 is actuated in a controlled manner such that a motor torque is generated on the basis of a rider torque generated by the rider's muscle power to provide motor assistance to the rider as they pedal. It is provided that the motor torque generation is controlled on the basis of an amount of rider torque.

The control unit 103 is configured so as to carry out a method for operating the drive unit 102. The method allows an optimized actuation of the drive unit 102 as a function of the rider torque as the bicycle is being ridden, i.e. in particular when the electric bicycle 100 is moving.

The process of the method will be described in detail below with reference to FIGS. 2 to 4.

FIG. 2 shows an exemplary view of a torque recording 60 that can be captured while ride the electric bicycle 100. The rider torque 62 is shown as a function of time 61. The rider torque 62 can be detected using a torque sensor 107 (see FIG. 1). Thus, in the torque recording 60 of FIG. 2, an exemplary temporal torque curve 55 of the rider torque 62 is shown.

As can be seen in FIG. 2, the current value of the rider torque 62 can change periodically over time 61, for example similar to a sinusoidal vibration.

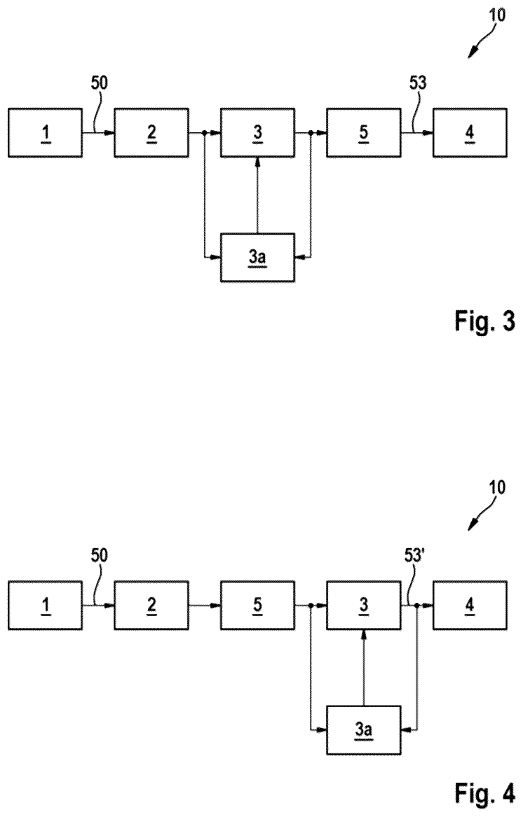

The process of the method 10 according to a first exemplary embodiment of the invention is shown schematically in FIG. 3 in a very simplified manner.

In the method, the determined rider torque 62, in particular its current value as determined by the torque sensor 107, is provided as a rider torque signal 50. In particular, the rider torque signal 50 thus has the same fluctuating curve as the temporal torque curve 55 shown in FIG. 2. This determining 1 of the rider torque signal 50 is carried out in the first method step.

Subsequently, a first filtering 2 of the rider torque signal 50 is carried out by means of a first low-pass filter. The first low-pass filter has a predetermined first time constant, which is constant. Thereby, a first smoothing of the rider torque signal 50 is carried out.

After the first filtering 2, preferably immediately thereafter, a second filtering 3 is carried out by means of a second low-pass filter. The second low-pass filter is configured as a separate filter from the first low-pass filter and has a variable time constant, by contrast to the first low-pass filter.

Following the second filtering 3 by means of the second low-pass filter, there is a multiplying 5 of the filtered rider torque signal 50 by a support factor.

For example, the support factor can be a predetermined constant numerical value. Alternatively preferably, the support factor can be variably configured and can be adjusted, for example, as a function of a level of the determined rider torque 62. Alternatively or additionally preferably, the support factor can be configured so as to be adjustable by a manual rider input of the rider.

As a function of the rider torque signal 53 multiplied by the support factor, the drive unit 102 is subsequently actuated by the control unit 103 in a controlled manner. This is done in the step of controlled generation 4 of the motor torque.

The variable time constant of the second low-pass filter is adjusted as a function of a difference of the rider torque signal 50 between an input and an output of the second low-pass filter. For this purpose, in an additional step, the determination 3a of the difference between the rider torque signal 50 at the input of the second low-pass filter and the rider torque signal 50 at the output of the second low-pass filter is carried out.

The adjustment of the second time constant can be carried out in a simple embodiment, such that the second time constant is increased during the course of executing the method 10, as the difference decreases. This is the case, for example, when the curve of the rider torque 55 exhibits comparatively low temporal fluctuations, for example in FIG. 2 in Section B.

Due to the increased second time constant, there is a stronger filtering or smoothing of the rider torque signal in the case of such low determined differences. Thus, for example, short-term changes of the rider torque are not immediately translated into a sharp change in motor torque, but rather a particularly uniform operation of the drive unit 102 is caused. This is particularly advantageous in travel situations where even movement of the electric bicycle 100 is desirable, when no strong changes to the motor torque specification are necessary. In this case, the particularly effective filtering by means of the second low-pass filter with a high time constant can provide a particularly high ride comfort, because, for example, undesirable motor torque fluctuations can be avoided.

Analogously, the second time constant can be decreased when the difference increases. This can be the case, for example, when the curve of the rider torque 55 exhibits large temporal fluctuations, for example in FIG. 2 in Section A.

Due to the second time constant, which is reduced in this case, it is achieved that, with such high differences, a less strong filtering or smoothing of the rider torque signal 50 occurs. As a result, the drive unit 102 responds more quickly and directly to the changes of the rider torque signal 50, thereby giving the rider the feeling that the drive is more responsive. This is particularly desirable in dynamically difficult ride situations, in order to provide a high level of ride comfort in these ride situations.

In an alternative or additional embodiment of method 10, the current value of the difference determined in step 3a is respectively monitored. When the determined difference is greater than or equal to a predetermined threshold difference, the variable second time constant of the second low-pass filter is reduced to a value less than or equal to a predetermined threshold time constant. Analogously, there is preferably an increase of the variable second time constant of the second low-pass filter to a value greater than the predetermined threshold time constant when the determined difference is less than the predetermined threshold difference. As a result, it possible to carry out the method 10 in a particularly straightforward and inexpensive manner.

FIG. 4 shows a highly simplified schematic view of a method 10 for operating a drive unit 102 of an electric bicycle 100 according to a second exemplary embodiment of the invention. The second exemplary embodiment substantially corresponds to the first exemplary embodiment of FIG. 3, with the difference being an alternative temporal sequence of the method steps. In detail, in the second embodiment, the rider torque signal 50 is multiplied 5 by the support factor temporally between the first filtering 2 and the second filtering 3. Thus, the rider torque signal 50 already multiplied by the support factor is filtered by means of the second low-pass filter at the second filter 3. The rider torque signal 53′ thus filtered and multiplied is subsequently provided directly to the step of controlled generation 4 of the motor torque.

Preferably, the rider torque signal 50 and/or the difference in each of the described exemplary embodiments can be continuously monitored, and the respective current value can be used in order to execute the method 10. Alternatively, a recording of the rider torque signal 50 and/or the difference over a predetermined time period is particularly advantageous is, wherein the adjusting of the variable second time constant of the second low-pass filter occurs as a function of that recording. A particularly simple embodiment of the method 10 can be provided when the adjusting of the variable second time constant of the second low-pass filter is carried out as a function of a determined maximum value of the recorded rider torque signal 50 and/or the difference within the predetermined time period.

1. A method for operating a drive unit of an electric bicycle, comprising:
determining a rider torque signal, which is based on a rider torque generated by way of muscle power of a person riding the electric bicycle,
first filtering the rider torque signal by way of a first low-pass filter,
second filtering the rider torque signal by way of a second low-pass filter, and
generating, in a controlled manner, a motor torque by way of the drive unit as a function of the rider torque signal filtered by way of the second low-pass filter.

2. The method according to claim 1, wherein the second low-pass filter has a variable time constant, which is adjusted as a function of the rider torque signal.

3. The method according to claim 2, further comprising:
determining a difference of the rider torque signal between an input and an output of the second low-pass filter, wherein the variable time constant of the second low-pass filter is adjusted as a function of the difference.

4. The method according to claim 3, wherein the variable time constant of the second low-pass filter is increased as it is determined that the difference is decreasing.

5. The method according to claim 3, wherein the variable time constant of the second low-pass filter is decreased as it is determined that the difference is increasing.

6. The method according to claim 3, wherein:
the variable time constant of the second low-pass filter is reduced to a value less than or equal to a predetermined threshold time constant when the determined difference is greater than or equal to a predetermined threshold difference, and/or
the variable time constant of the second low-pass filter is increased to a value greater than the predetermined threshold time constant when the determined difference is less than the predetermined threshold difference.

7. The method according to claim 1, wherein:
the determining of the rider torque signal comprises recording the rider torque signal over a predetermined time period, and
the adjusting of the variable time constant is carried out as a function of the recorded rider torque signal.

8. The method according to claim 7, further comprising determining a maximum value of the recorded rider torque signal, wherein the adjusting of the variable time constant is carried out as a function of the maximum value.

9. The method according to claim 1, further comprising multiplying the rider torque signal by a support factor, wherein the controlled generation of the motor torque is carried out by way of the rider torque signal that has been multiplied by the support factor.

10. The method according to claim 9, wherein the multiplying of the rider torque signal occurs before or after the second filtering step.

11. The method according to claim 1, wherein the first low-pass filter has a predetermined, constant time constant.

12. An electric bicycle comprising a drive unit and a control unit configured so as to actuate the drive unit in a controlled manner, wherein the control unit is further configured so as to carry out a method according to claim 1.
